(19) United States
(12) Patent Application Publication
(10) Pub. No.: US 2006/0279483 A1
(43) Pub. Date: Dec. 14, 2006

(54) Method and apparatus for driving plasma display panel

(75) Inventors: Yu Tsung Tsai, Puzih City (TW); Nan Chun Liu, Daliao Township (TW); Meng Hung Chien, Danshuei Township (TW)

Correspondence Address: TROXELL LAW OFFICE PLLC, SUITE 1404, 5205 LEESBURG PIKE, FALLS CHURCH, VA, 22041, US

(73) Assignee: Formosa Plasma Display Corp.

(21) Appl. No.: 11/147,282

(22) Filed: Jun. 8, 2005

(51) Int. Cl. G09G 3/28

(52) U.S. Cl. 345/67

(57) ABSTRACT

A method for driving plasma display panel is disclosed. The plasma display panel comprises a plurality of discharge units composed by a plurality of address electrodes, sustain electrodes and scan electrodes. Its driving method is characterized by using a set of sustain electrode control signals and a set of scan electrode control signals to apply pulse signals of predefined voltage to respectively a plurality of sustain electrodes and a plurality of scan electrodes over a predefined period of time during the sustain discharge period to enable them to alternately discharge and emit light, wherein during the sustain discharge period, either the scan electrode (Y electrode) or the sustain electrode (X electrode) is maintained at a constant potential and another electrode is used to generate the differential voltage required for alternate discharge between the sustain electrodes and scan electrodes to achieve the effect of continuous discharge and illumination. As such, the circuit design for the electrode having a constant potential may be greatly simplified, thereby offering the advantages of simplifying the driving waveform and lowering the circuit cost.

### BACKGROUND OF INVENTION

1. Field of the Invention

The present invention relates to a method for driving plasma display panel, in particular, a method for achieving the functions of simplifying the driving waveform and lowering the circuit cost by maintaining the potential of either the scan electrode (Y electrode) or sustain electrode (X electrode) of the plasma display panel at a constant level and using another electrode to generate differential voltage required for the alternate discharge between sustain electrode and scan electrode within a sustain discharge period.

2. Description of the Prior Art

FIG. 1A and FIG. 1B are respectively a schematic view and a cross-sectional view of a conventional AC plasma display panel 1 (referring as PDP hereinafter). The PDP 1 has an upper substrate 11 and a lower substrate 12. The inner side of upper substrate 11 is configured in sequence with a plurality of parallel transparent electrodes 111, a plurality of bus electrodes 112, a dielectric layer 113 and a protective layer 114. The corresponding lower substrate 12 is disposed in sequence with a plurality of parallel address electrodes 121, a dielectric layer 124, a plurality of partition ribs 122 arranged in parallel, and a phosphor 123. When the upper substrate 11 and the lower substrate 12 are aligned, transparent electrodes 111 and address electrodes 121 are perpendicular to each other and a discharge unit 13 forms at the junction.

As described above, the inner side surface of upper substrate 11 is disposed with a plurality of parallel arrayed, spaced apart transparent electrodes 111, and bus electrode 112 is stacked on transparent electrode 111 to lower its line impedance. According to related art, the discharge unit 13 employs the three-electrode approach. That is, a three-electrode configuration is formed with two adjacent parallel transparent electrodes 111 (sustain electrode 111a and scan electrode 111b) on upper substrate 11 and an address electrode 121 at a corresponding position on lower substrate 12. When voltage is applied to those electrodes, high-voltage discharge occurs to generate plasma and emits ultraviolet light, which in turn excites the phosphor 123 coated inside the discharge unit 13 to emit red, green, and blue visible rays.

In the prior art, one frame of the PDP consists of several sub-frames generated in sequence. The display of each frame takes three steps to achieve, that is, reset, address and sustain discharge. The reset step is to restore the charge distribution of all electrodes back to initial state; the address step is to let the scan electrode 111b in the discharge unit 13 of predetermined location to build sufficient wall charge so that alternate discharge and emit light as induced by the pulsed voltage applied at a predetermined frequency can occur in subsequent sustain discharge steps.

Referring to FIG. 1A and FIG. 2A, one of the sustain discharge techniques for PDP of related art is that after entering the sustain discharge period following addressing, the PDP 1 would apply pulsed voltage at a predetermined frequency to the parallel sustain electrode (X electrode) 111a and scan electrode (Y electrode) 111b and maintain a constant differential voltage required for alternate discharge between X electrode and Y electrode (as shown in the sustain discharge period of FIG. 2A).

Referring to FIG. 3, in order for the driving apparatus of conventional PDP 30 to generate pulsed voltage of opposite polarity for X electrode and Y electrode, it is necessary to connect X electrode and Y electrode to a sustain electrode (X electrode) driving circuit 32 and scan electrode (Y electrode) driving circuit 33 respectively and have a control circuit 34 to control the connection, while the address electrode (A electrode) is driven by an address electrode driving circuit 31. The sustain electrode driving circuit 32 and scan electrode driving circuit 33 further contains respectively a X electrode sub-circuit 35 and a Y electrode sub-circuit 36. Those sub-circuits 35 and 36 are for applying voltage of opposite polarity to X electrode and Y electrode during the sustain discharge period and producing cyclic switch of voltage polarity so that X electrode and Y electrode can undergo alternate discharge continuously. The X electrode sub-circuit 35 and Y electrode sub-circuit 36 can have identical configuration. Thus only the configuration of the former is depicted (as shown in FIG. 2B) and discussed below.

As shown in FIG. 2B, the X electrode sub-circuit 35 further includes a pulsed voltage generating circuit 351, an energy recovery circuit 352, and a constant potential circuit 353. The constant potential circuit 353 may be, for example, a ground circuit. The pulsed voltage generating circuit 351 further consists of a first switch 3511 connected to a positive voltage source +Vs, a second switch 3512 connected to a negative voltage source −Vs, a first diode 3513 and a second diode 3514. The on/off state of the first switch 3511 and the second switch 3512 is controlled respectively by signal S1 and signal S2. The output end of first switch 3511 and the input end of second switch 3512 are respectively connected to first diode 3513 and second diode 3514 having opposite polarity. The other ends of first diode 3513 and second diode 3514 join each other and then connect to output end 354 of X electrode sub-circuit 35. The pulsed voltage generating circuit 351 is mainly controlled by signal S1 and signal S2 so that the first switch 3511 which connects to a positive voltage source and the second switch 3512 which connects to a negative voltage source can alternately turn on the charge flow in a short time and positive voltage +Vs and negative voltage −Vs switch continuously at the output end 354. Given that the pulsed voltage generating circuit 351 continuously and cyclically in a very short time at the same output end 354, it is unavoidable that the residual charge from the previous wave of output voltage would offset the emitted inverse voltage that follows, resulting in loss of energy. Thus the prior art as shown in FIG. 2B must use an energy recovery circuit 352 to recover energy. The energy recovery circuit 352 uses a third switch 3521 with grounded input end and a third diode 3522 to serially connect to a first inductor 3523 and then link to the output end of first switch 3511. Similarly, the energy recovery circuit 352 uses a fourth switch 3524 with grounded output end and a fourth diode 3525 to serially connect to a second inductor 3526 and then link to the input end of the second switch 3512. The third switch 3521 and the fourth switch 3524 are respectively controlled by signal S3 and signal S4. Through the design of an energy recovery circuit 352, only the third switch 3521 and the first switch 3511 need to be turned on successively (the fourth switch 3524 and the second switch 3512 are in “off” state at this time) in order to output positive voltage +Vs. And the output of negative voltage −Vs may be achieved by turning on the fourth switch 3524 and the second switch 3512 successively and turning off the third switch 3521 and the first switch 3511. As such, the energy recovery circuit 352 can cut down energy loss brought about by high frequency output of positive and negative pulse signals. In addition, The constant potential circuit 353 in the X electrode sub-circuit 35 consists mainly of a fifth switch 3531 controlled by signal S5 and a sixth switch 3532, where one end of the constant potential circuit 353 is grounded, while the other end is connected to the output end 354 of X electrode sub-circuit 35. By turning on fifth switch 3531 and sixth switch 3532 through the input of signal S5, the residual voltage remained at the output end 354 of X electrode sub-circuit 35 may be grounded out directly to achieve the effect of voltage removal and zero-in.

It is apparent from the descriptions above that the addition of an energy recovery circuit 352 to improve the situation of energy offset between X electrode sub-circuit 35 and Y electrode sub-circuit 36 in the prior art complicates the circuit design and increase the overall cost of the product.

### SUMMARY OF INVENTION

The primary object of the present invention is to provide a method and apparatus for driving plasma display panel (PDP) that effectively simplifies the driving circuit configuration of some electrodes without sacrificing display quality, hence helping to lower cost, increase profit and render the PDP more price competitive.

Another object of the present invention is to provide a method and apparatus for driving plasma display panel, characterized in which the potential of either the sustain electrode or scan electrode is kept at a constant voltage during the sustain discharge period and another electrode is used to generate differential potential required for alternate discharge so as to simplify the driving waveform generated by the electrode having constant potential.

In a preferred embodiment of the present invention, the plasma display panel comprises a plurality of discharge units composed by a plurality of address electrodes, sustain electrodes and scan electrodes. Its driving method is characterized by using a set of sustain electrode control signals and a set of scan electrode control signals to apply pulse signals of predefined voltage to respectively a plurality of sustain electrodes and a plurality of scan electrodes over a predefined period of time during a sustain discharge period, wherein by maintaining the potential of either the sustain electrodes or the scan electrode arranged in parallel at a constant level and driving another electrode to generate the differential voltage required for alternate discharge between the sustain electrodes and scan electrodes, the effect of continuous discharge and illumination is achieved. As such, the driving waveform generated by the electrode having constant potential and the configuration of sustain circuit for driving said electrode are simplified, which helps saves cost.

### BRIEF DESCRIPTION OF THE DRAWINGS

The details of the present invention will be more readily understood from a detailed description of the preferred embodiments taken in conjunction with the following figures.

FIG. 1A is a schematic view of a conventional AC plasma display panel.

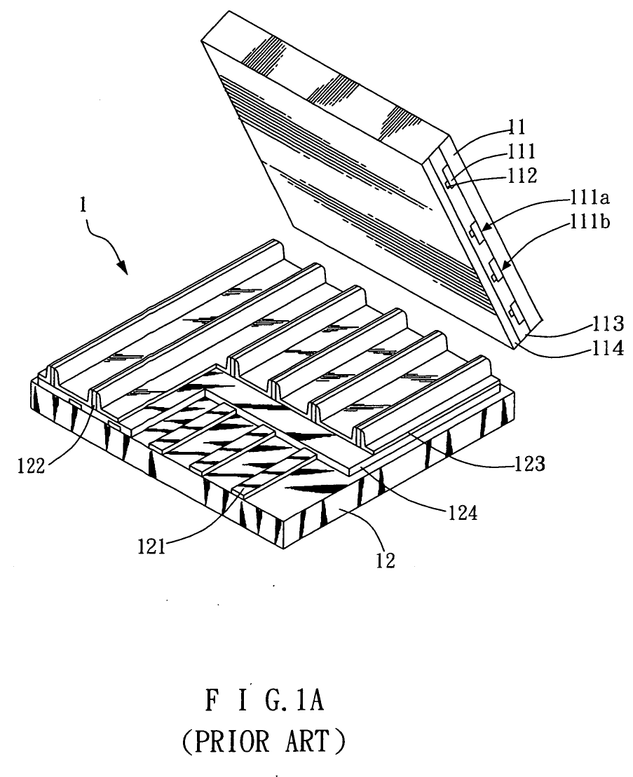

FIG. 1B is a cross-sectional view of a conventional AC plasma display panel.

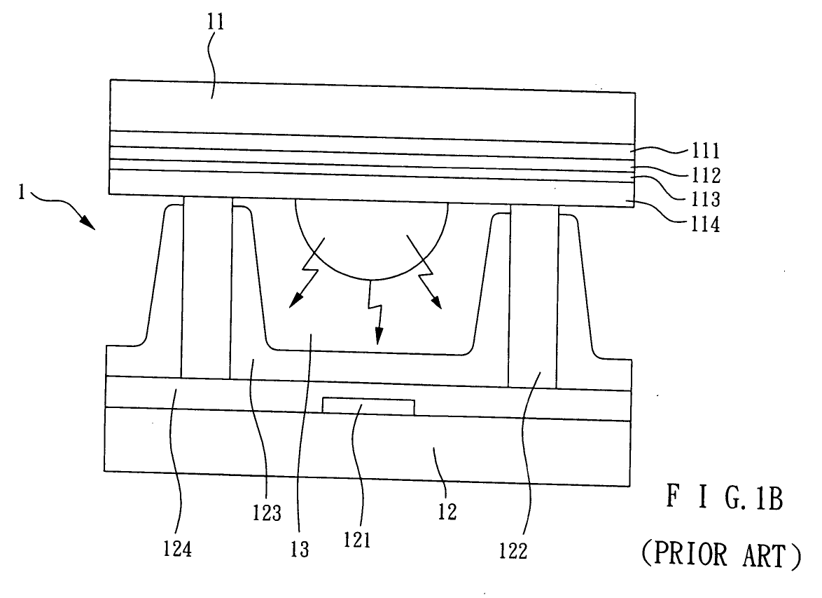

FIG. 2A shows the time-series driving waveforms of a conventional plasma display panel.

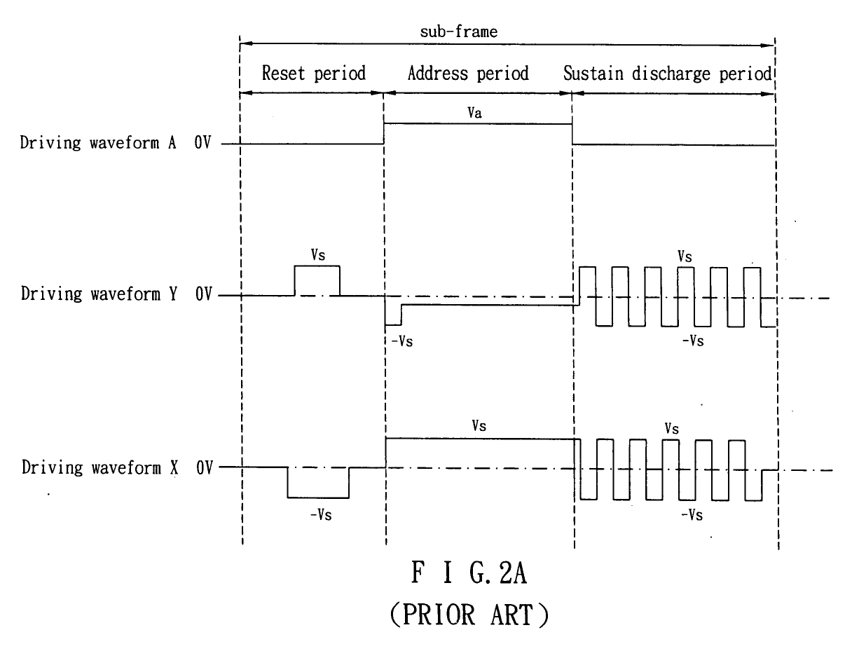

FIG. 2B is the sustain electrode sub-circuit in the driving apparatus of a conventional plasma display panel.

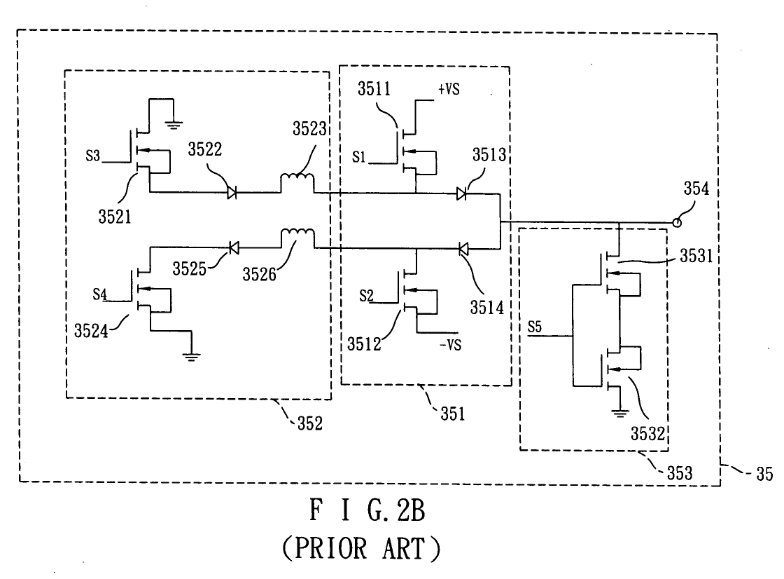

FIG. 3 is a driving apparatus of the first embodiment of a plasma display panel according to the invention.

FIG. 4 shows the time-series driving waveforms of the first embodiment of a plasma display panel according to the invention.

FIG. 5 is the sustain electrode sub-circuit in the driving apparatus of the preferred embodiment of a plasma display panel according to the invention.

### DETAILED DESCRIPTION

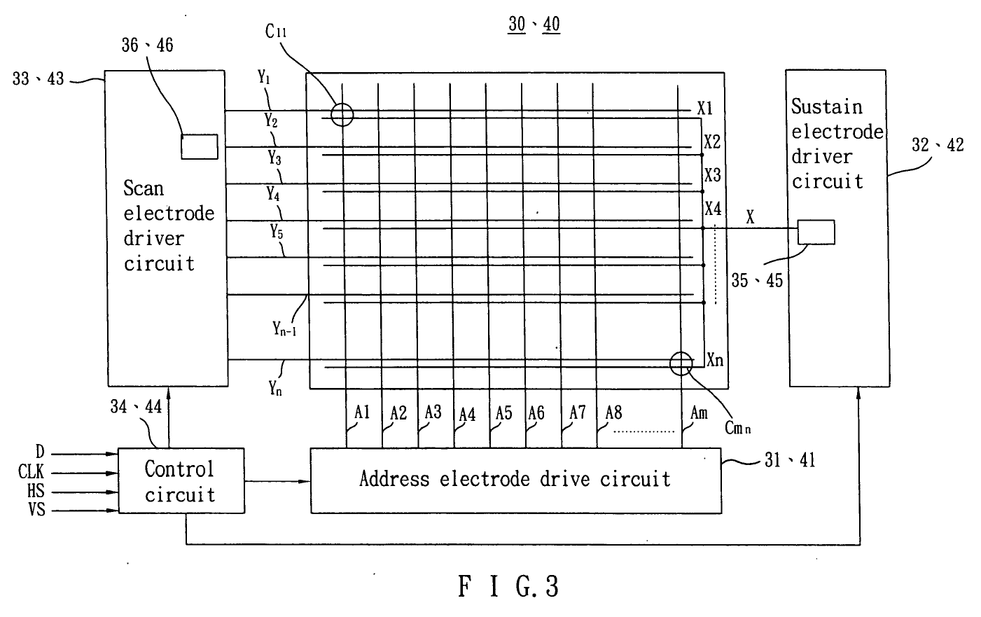

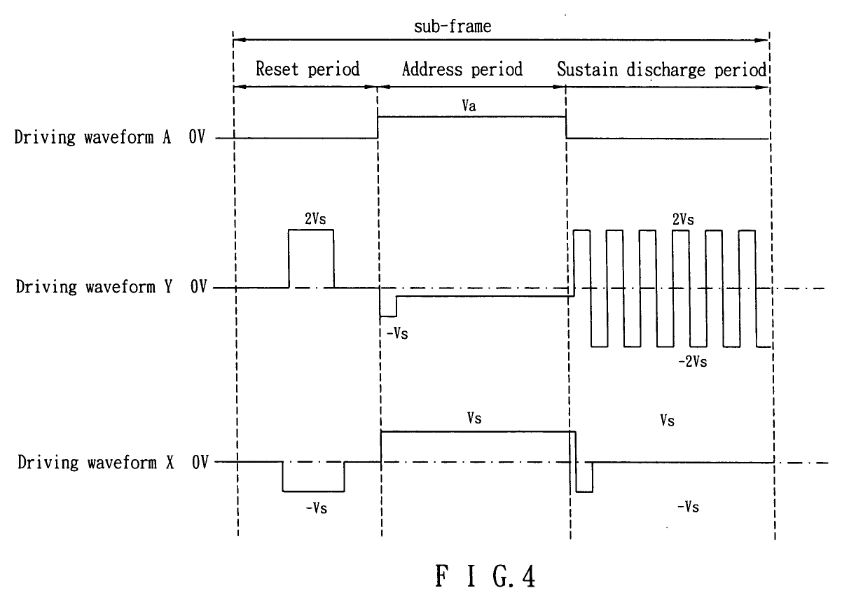

Referring to FIG. 3 and FIG. 4 which illustrate the first preferred embodiment of the method and apparatus for plasma display panel according to the invention, FIG. 3 shows the driving apparatus 40 in the first preferred embodiment of the plasma display panel. FIG. 4 shows the time-series driving waveforms in the first preferred embodiment.

As shown in FIG. 3, the plasma display panel in this embodiment consists of a plurality of address electrodes arranged at a predefined space apart (A1, A2, . . . Am), a plurality of sustain electrodes arranged at a predefined space apart (X1, X2, X3 . . . Xn), and a plurality of scan electrodes arranged at a predefined space apart (Y1, Y2, Y3, . . . Yn). Each sustain electrode (X1, X2, X3 . . . Xn) and scan electrode (Y1, Y2, Y3, . . . Yn) are alternately arrayed in parallel to each other and intersect respectively with address electrode (A1, A2, . . . Am) in the direction of projection to constitute a plurality of discharge units (C11, . . . Cmn). The driving apparatus for plasma display panel 40 in this embodiment comprises an address electrode driving circuit 41, a sustain electrode driving circuit 42, a scan electrode driving circuit 43 and a control circuit 44.

Again referring to FIG. 3, the address electrode driving circuit 41 is coupled to the address electrodes (A1, A2, . . . Am) to drive individual address electrode (A1, A2, . . . Am). In this embodiment, the sustain electrodes (X1, X2, X3 . . . Xn) are connected in parallel into a single source X before coupling to the sustain electrode driving circuit 42 so that sustain electrode driving circuit 42 can drive all sustain electrodes (X1, X2, X3 . . . Xn) simultaneously with the output of the same control signals. The scan electrode driving circuit 43 is coupled to the scan electrodes (Y1, Y2, Y3, . . . Yn) and drives the scan electrodes (Y1, Y2, Y3, . . . Yn) individually. The control circuit 44 is coupled to the address electrode driving circuit 41, the sustain electrode driving circuit 42, and the scan electrode driving circuit 43 to control the actuation of respective driving circuits. In this embodiment, the sustain electrode driving circuit 42 and the scan electrode driving circuit 43 are respectively further configured with a sustain electrode sub-circuit 45 and a scan electrode sub-circuit 46. During the sustain discharge period, the control circuit 44 controls the sustain electrode driving circuit 42, and the scan electrode driving circuit 43 to generate respectively a set of sustain electrode control signals and a set of scan electrode control signals so as to apply pulsed signal of predefined voltage to the plurality of sustain electrodes (X1, X2, X3 . . . Xn) and the plurality of scan electrodes (Y1, Y2, Y3, . . . Yn) over a predefined period of time to enable discharge units (C11, . . . Cmn) at predetermined locations to discharge and emit light continuously.

The method for driving plasma display panel disclosed herein primarily aims to provide simpler waveform and driving circuit configuration. Therefore, only the time-series waveforms during sustain discharge period of one sub-frame according to the first preferred embodiment as shown in FIG. 4 are discussed. The other sequential periods in the operation, such as reset period and address period are not the main technical features of this invention and will not be discussed herein. Proper sequential techniques for reset period and address period from prior art may be used in conjunction with the technique for sustain discharge period as provided in the invention.

Again referring to FIG. 3 and FIG. 4 which show the first preferred embodiment of the method for driving plasma display panel, the control circuit 44, during a sustain discharge period, controls X electrode (sustain electrode) driving circuit 42 to generate a predefined constant voltage pulse signal to respective X electrode (X1, X2, X3 . . . Xn), and simultaneously controls Y electrode (scan electrode) driving circuit 43 to generate pulse signal of predefined frequency and predefined polarity to respective Y electrode (Y1, Y2, Y3, . . . Yn). As shown in FIG. 4, during the sustain discharge period, X electrode is first switched from a positive voltage +Vs to a negative voltage −Vs as initial voltage. At the same time, Y electrode takes +2Vs as initial voltage. Consequently the differential voltage between electrodes X and Y is greater than the voltage differential required to initiate a discharge. Subsequently, X electrode returns to a steady voltage (e.g. 0 volt) without further changes, while Y electrode undergoes cyclic change in voltage between +2Vs and −2Vs to provide the differential voltage (2Vs) needed for the alternate discharge between X electrode and Y electrode, thereby achieving the purpose of sustained discharge.

It is clear in the description of this preferred embodiment that because X electrode only needs to maintain a constant voltage during the sustain discharge period, it helps simplify its driving waveform. Similarly the circuitry of X electrode sub-circuit 45 configured in the sustain electrode driving circuit 42 may be simplified by omitting the design of an energy recovery circuit 352 as required in the X electrode sub-circuit 35 of conventional plasma display panel, since cyclic polarity change of X electrode is no longer required. With saving in circuit cost, manufacturers can expect higher profit and offer more price competitive products on the market.

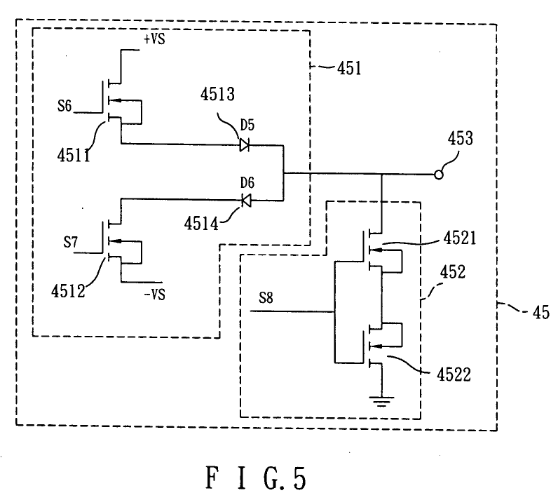

Continuing on with FIG. 5, which depicts the circuitry diagram of X electrode sub-circuit in the preferred embodiment, the biggest difference between the X electrode sub-circuit 45 and the prior art is that the former does not require the arrangement of an energy recovery circuit to reduce energy loss since high frequency cyclic switch of voltage polarity during the sustain discharge period. In FIG. 5, the X electrode sub-circuit 45 is made of a pulsed voltage generating circuit 451 and a constant potential circuit 452, wherein the latter may be, for example, a ground circuit, and the former further consists of a seventh switch 4511 connected to a positive voltage source +Vs, an eighth switch 4512 connected to a negative voltage source −Vs, a fifth diode 4513 and a sixth diode 4514. The output end of seventh switch 4511 and the input end of eighth switch 4512 are respectively connected to the fifth diode 4513 and the sixth diode 4514 and controlled respectively by signal S6 and signal S7. The other ends of fifth diode 4513 and sixth diode 4514 are serially connected and then connect to output end 453. The pulsed voltage generating circuit 451 uses the seventh switch 4511 connected to a positive voltage source +Vs and the eighth switch 4512 connected to a negative voltage source −Vs to turn on the charge flow and positive voltage +Vs and negative voltage −Vs switch continuously at the output end 453. The constant potential circuit 452 in the X electrode sub-circuit 45 consists of a ninth switch 4521 and a tenth switch 4522 controlled by signal S8. One end of the constant potential circuit 452 is grounded, while the other end is connected to the output end 453 of X electrode sub-circuit 45. By turning on ninth switch 4521 and tenth switch 4522 through the input of signal S8, electric charge remained at the output end 453 of X electrode sub-circuit 45 may be directly grounded out to achieve the effect of voltage removal and zero-in.

The description above relates to merely one preferred embodiment of the invention. In fact, the invention can also keep the potential of Y electrode (scan electrode) constant and have X electrode to generate the differential voltage required for alternate discharge between X electrode and Y electrode and perform cyclic switch of polarity, while similarly offering the advantage of simplifying the circuitry of Y electrode.

Also in the design of maintaining the potential of either X electrode or Y electrode at a constant level and using another electrode to generate the differential voltage required for alternate discharge between X electrode and Y electrode and perform cyclic switch of polarity described in the invention, the constant potential can have a value other than the 0 volt for X electrode as shown in FIG. 5.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A method for driving plasma display panel, the plasma display panel comprising a plurality of address electrodes, a plurality of sustain electrodes and a plurality of scan electrodes, wherein each sustain electrode and each scan electrode are parallel arrangement and are respectively intersect with the address electrodes in the direction of projection to constitute a plurality of discharge units; the method for driving said plasma display panel comprising the steps of:
during a sustain discharge period, using respectively a set of sustain electrode control signals and a set of scan electrode control signals to apply pulse signals of predefined voltage to said sustain electrodes and scan electrodes over a predefined period of time to enable the discharge units at predetermined locations to undergo sustained discharge;
wherein potential of either the sustain electrodes or the scan electrodes is kept at a constant level, while potential of the other electrodes is variable so as to produce a differential voltage required for discharge between the sustain electrodes and the scan electrodes.

2. The method for driving plasma display panel according to claim 1, wherein the electrodes with constant potential are the sustain electrodes.

3. The method for driving plasma display panel according to claim 1, wherein at a beginning period of sustain discharge, the sustain electrodes and scan electrodes are respectively given an initial voltage with opposite polarity.

4. The method for driving plasma display panel according to claim 1, wherein during the sustain discharge period, the sustain electrodes are parallel connected such that single signal controls all sustain electrodes.

5. A method for driving plasma display panel, the plasma display panel comprising a plurality of address electrodes, a plurality of sustain electrodes and a plurality of scan electrodes; the method for driving said plasma display panel comprising the steps of:
during a sustain discharge period, the sustain electrodes receive a set of sustain electrode control signals, which first give the sustain electrodes an initial voltage and then maintain constant voltage of said sustain electrodes, whereas the scan electrodes receive a set of scan electrode control signals which first give the scan electrodes an initial voltage with polarity opposite to the initial voltage of sustain electrodes and then control said scan electrodes to produce cyclic voltage variations to maintain a differential voltage required for discharge between the sustain electrodes and the scan electrodes.

6. The method for driving plasma display panel according to claim 5, wherein each sustain electrode and each scan electrode are parallel arrangement and are respectively intersect with the address electrodes in the direction of projection to constitute a plurality of discharge units.

7. The method for driving plasma display panel according to claim 5, wherein during the sustain discharge period, the sustain electrodes are parallel connected such that single signal controls all sustain electrodes.

8. An apparatus for driving plasma display panel, the plasma display panel comprising a plurality of address electrodes, a plurality of sustain electrodes and a plurality of scan electrodes, wherein each sustain electrode and each scan electrode are parallel arrangement and are respectively intersect with the address electrodes in the direction of projection to constitute a plurality of discharge units; the apparatus for driving plasma display panel comprising:
an address electrode driving circuit coupled to the address electrodes to drive the address electrodes;
a sustain electrode driving circuit coupled to the sustain electrodes to drive the sustain electrodes;
a scan electrode driving circuit coupled to the scan electrodes to drive the scan electrodes; and
a control circuit coupled to the address electrode driving circuit, the sustain electrode driving circuit and the scan electrode driving circuit to control the actuation of those driving circuits;
wherein during a sustain discharge period, the control circuit keeps the potential of either the scan electrodes or sustain electrodes at a constant level while enabling the other electrodes to undergo cyclic voltage variations to produce a differential voltage required for discharge between sustain electrodes and scan electrodes.

9. The apparatus for driving plasma display panel according to claim 8, wherein the electrodes with constant potential are the sustain electrodes.

10. The apparatus for driving plasma display panel according to claim 9, wherein the sustain electrode driving circuit for controlling the sustain electrodes further comprises a sustain electrode sub-circuit composed mainly of a pulsed voltage generating circuit and a constant potential circuit.

11. The apparatus for driving plasma display panel according to claim 8, wherein at a beginning period of sustain discharge, the scan electrode driving circuit and the sustain electrode driving circuit give respectively the scan electrodes and the sustain electrodes an initial voltage with opposite polarity.

12. The apparatus for driving plasma display panel according to claim 8, wherein during the sustain discharge period, the sustain electrodes are parallel connected such that the sustain electrode driving circuit generates single signal to control simultaneously all sustain electrodes.
